(19) United States
(12) Patent Application Publication
(10) Pub. No.: US 2025/0229137 A1
(43) Pub. Date: Jul. 17, 2025

(54) METHODS AND APPARATUS TO GENERATE PHYSICAL THERAPY EXERCISE PROFILES

(71) Applicants: Ron Alfia, Haifa (IL); Amit Gur, Ein Vered (IL); Dan Horovitz, Rishon Letzion (IL); Uzi Sarel, Zichron-Yaakov (IL); Yael Yankelevsky, Haifa (IL)

(72) Inventors: Ron Alfia, Haifa (IL); Amit Gur, Ein Vered (IL); Dan Horovitz, Rishon Letzion (IL); Uzi Sarel, Zichron-Yaakov (IL); Yael Yankelevsky, Haifa (IL)

(21) Appl. No.: 19/094,740

(22) Filed: Mar. 28, 2025

(51) Int. Cl. A63B 24/00; A63B 71/06; G06V 10/75; G06V 20/40; G06V 40/20

(52) U.S. Cl. CPC A63B 24/0075; A63B 71/0622; G06V 10/75; G06V 20/40; G06V 40/20; A63B 2071/0647; A63B 2220/05; G06V 2201/10

(57) ABSTRACT

Systems, apparatus, articles of manufacture, and methods are disclosed to generate physical therapy exercise profiles. An example non-transitory machine readable storage medium comprising instructions to cause programmable circuitry to at least: obtain, via a user interface, an indication of a characteristic for an exercise; obtain, via the user interface, a video depicting a person performing the exercise; analyze, using a machine learning algorithm, the video to detect a body position and a movement of the person performing the exercise; and cause an exercise profile to be stored for the exercise, the exercise profile including the indication of the characteristic for the exercise, an identification of the body position, and an identification of the movement.

### BACKGROUND

Physical therapists utilize many technological tools to aid in the provision of services to their clients. One technology that has been utilized is computer-aided exercise monitoring. In such systems, a customer may perform an exercise in front of a camera (e.g., at home, at a physical therapist's office, in a gym, etc.) and a computer may analyze the video from the camera to evaluate the client's performance of the exercise (e.g., to monitor repetitions of the exercise, to determine if the exercise is being performed properly, to track improvements in a client's condition, etc.).

### BRIEF DESCRIPTION OF THE DRAWINGS

FIG. 1 is a block diagram of an example environment in which an example exercise profiling device operates to generate exercise profiles based on video input.

FIGS. 2-3 are flowcharts representative of example machine readable instructions and/or example operations that may be executed, instantiated, and/or performed by example programmable circuitry to implement the exercise profiling device of FIG. 1.

FIG. 4 illustrates an example system for presenting and monitoring performance of an exercise.

FIGS. 5-6 illustrate example user interfaces for the exercise profiling device of FIG. 1.

FIG. 7 is a block diagram of an example processing platform including programmable circuitry structured to execute, instantiate, and/or perform the example machine readable instructions and/or perform the example operations of FIGS. 2-3 to implement the exercise profiling device of FIG. 1.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 2-3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

A physical therapy profile is a representation of an exercise that can be utilized to present the exercise to a physical therapy client and compared against to monitor performance of the exercise by the client. For example, a physical therapy profile may include parameters representative of the exercise (e.g., parameters indicative of body positions at various times during the exercise), one or more videos illustrating proper performance of the exercise, and other data associated with the exercise. To generate and store an exercise profile, an expert algorithm engineer typically works closely with a physical therapist who defines the exercise or utilizes a corpus of knowledge about the physical exercise. This approach is a bottleneck on the number of physical exercises being digitalized by the availability of expert algorithm engineers.

Methods and apparatus disclosed herein facilitate the generation of an exercise profile via computerized analysis of one or more videos illustrating example demonstration of the exercise (e.g., a video of the physical therapist performing the exercise). For example, by utilizing computerized analysis of one or more videos, a physical therapist may be enabled to quickly generate a new exercise profile (e.g., without the aid of an algorithm engineer).

In some examples, a physical therapist provides characteristics and information regarding an exercise to be generated (e.g., characteristics regarding an exercise category, characteristics of a video to be provided (e.g., a view type identifier, equipment needed for an exercise, annotations for the video (e.g., an indication of timestamps at which important parts of the exercise are performed-start, end, peak, trough, etc.), etc. The physical therapist also provides the video(s) demonstrating proper performance of the exercise. Examples disclosed herein utilize machine learning techniques to analyze the videos based on the parameters to determine a digital representation of the exercise, perform motion tracking, identify skeletal positions associated with the exercise, etc.

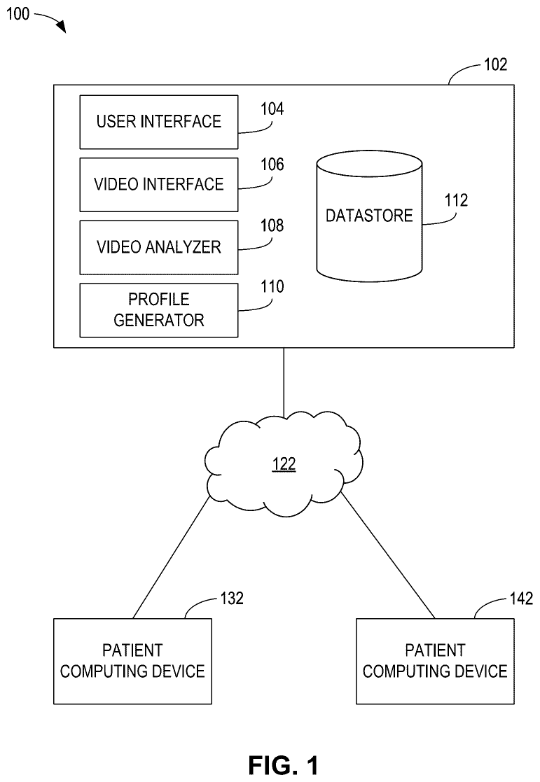

FIG. 1 is a block diagram of an example environment 100 in which an example exercise profiling device 102 operates to generate exercise profiles based on video input.

The example environment 102 includes the example exercise profiling device 102, an example network 122, an example physical therapist computing device 132 and an example patient computing device 142. A physical therapist may utilize the physical therapist computing device 132 to interact with the exercise profiling device 102 to generate new exercise profiles. A patient may utilize the patient computing device 142 to access exercises and monitor their performance of such exercises (e.g., via a camera of the patient computing device 142).

The exercise profiling device 102 of FIG. 1 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the exercise profiling device 102 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example exercise profiling device 102 includes an example user interface 104, an example video interface 106, an example video analyzer 108, and an example profile generator 110.

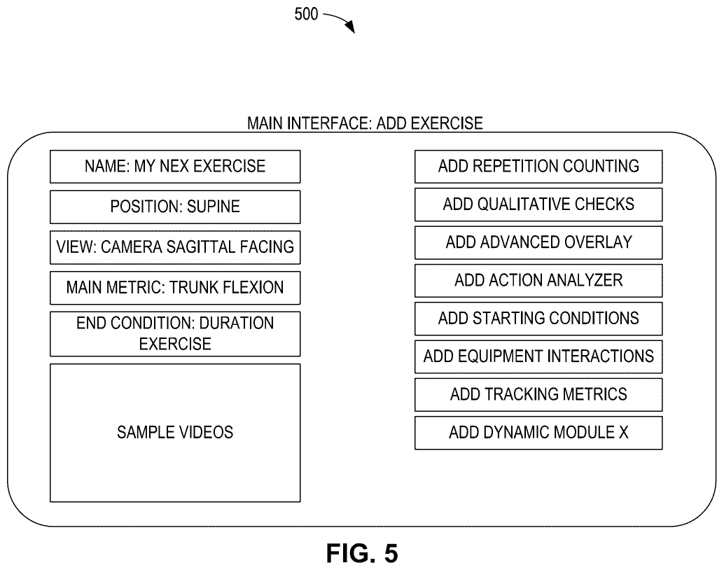

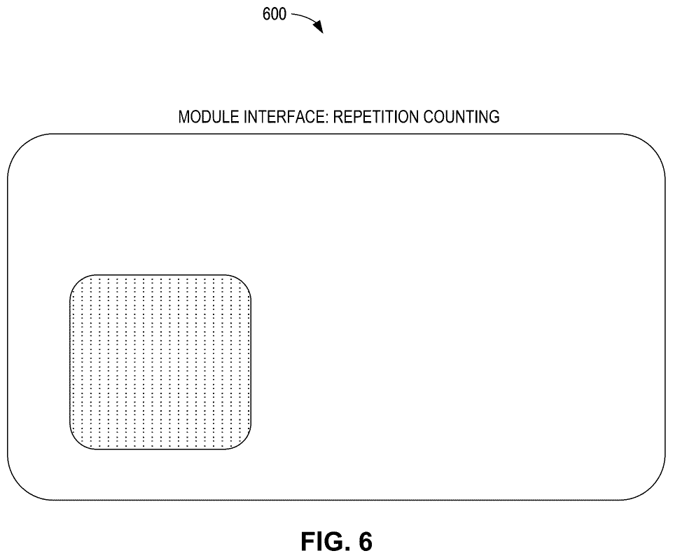

The example user interface 104 provides one or more user interfaces for a physical therapist to interact with the exercise profiling device 102. For example, the user interface 104 may provide a webpage user interface that is accessible by the physical therapist computing device 132. Alternatively, any other type of user interface may be provided. Example user interfaces are illustrated in FIGS. 5 and 6.

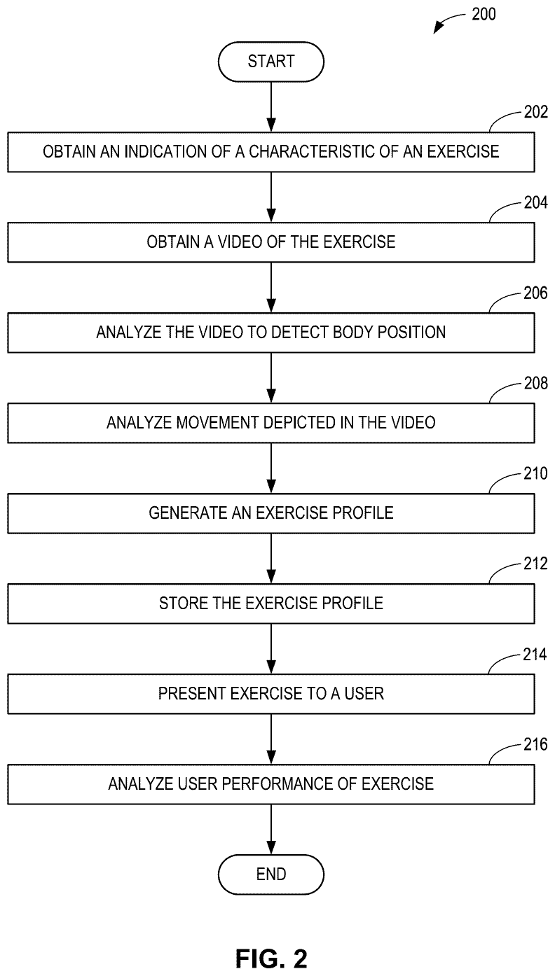

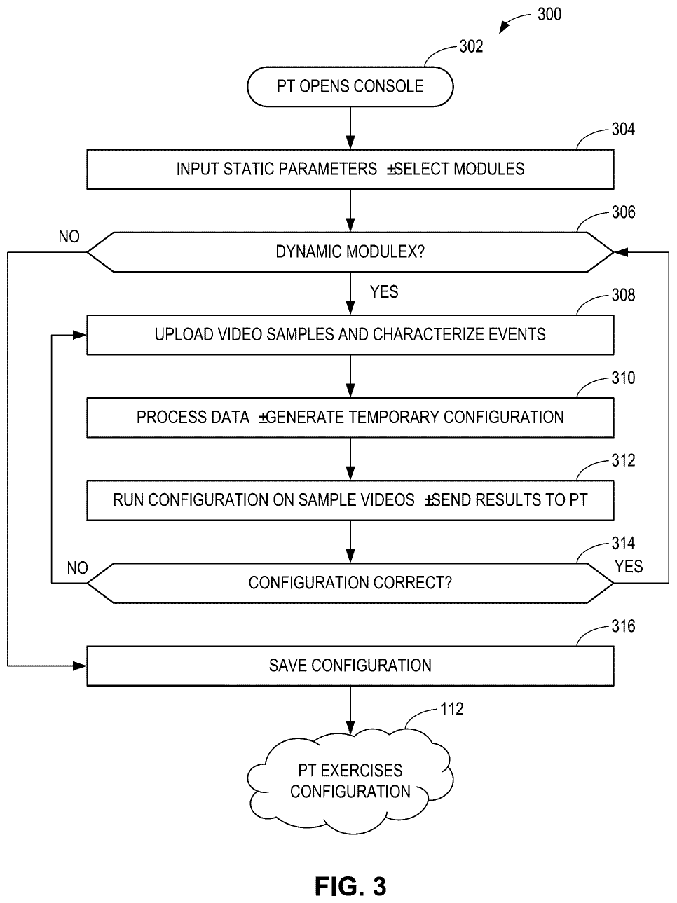

In some examples, the user interface 104 is instantiated by programmable circuitry executing user interface instructions and/or configured to perform operations such as those represented by the flowchart(s) of FIGS. 2-3.

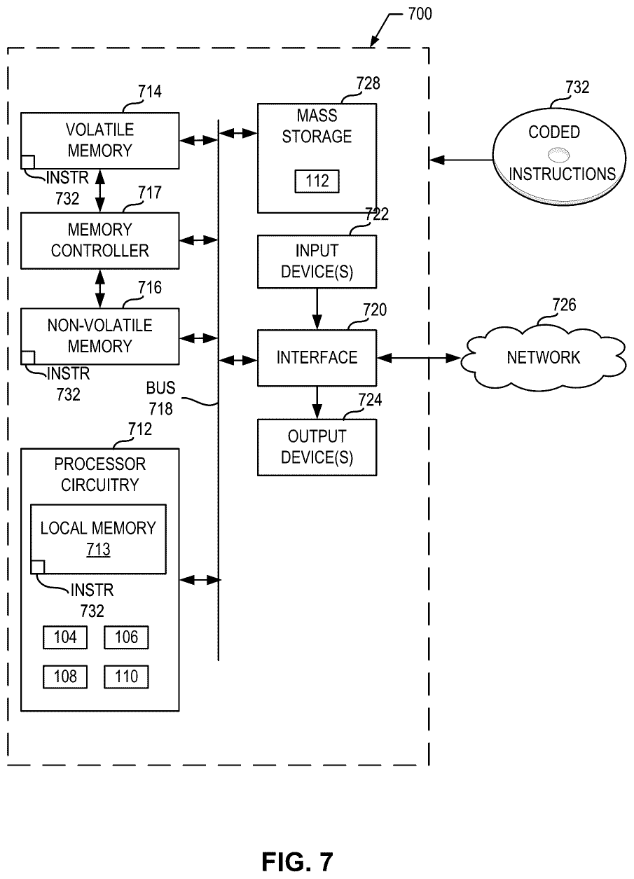

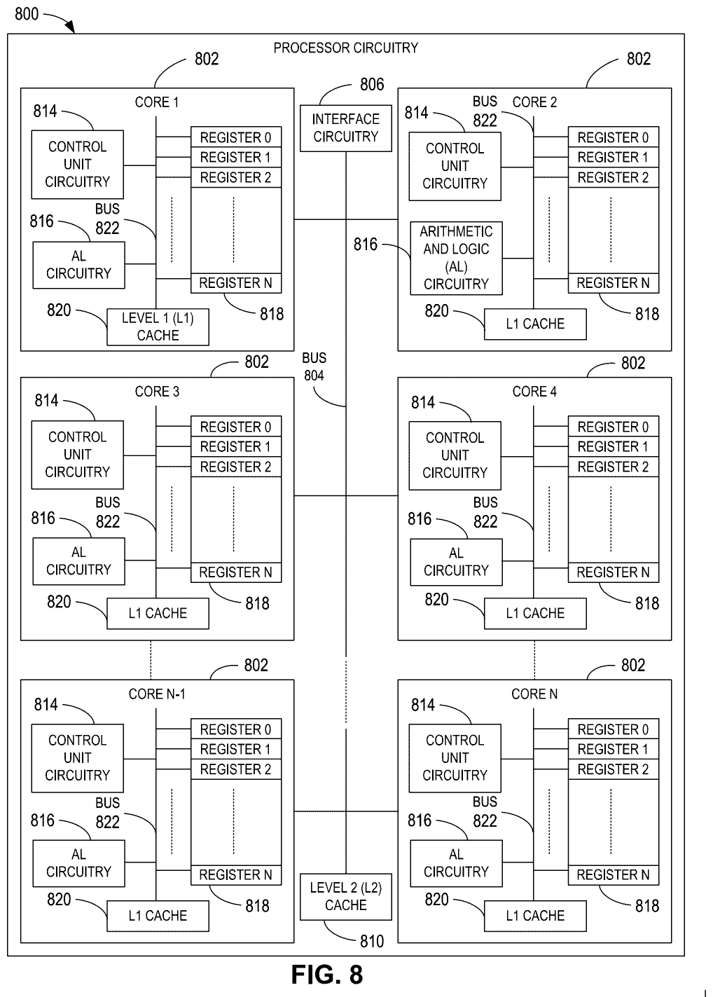

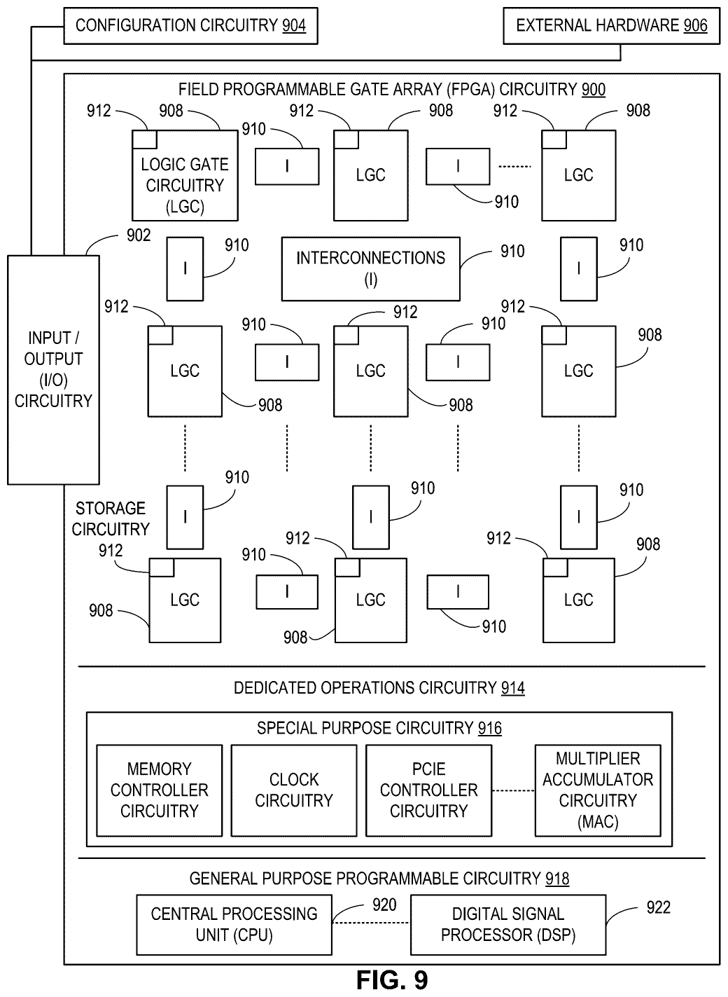

In some examples, the exercise profiling device 102 includes means for presenting a user interface. For example, the means for presenting a user interface may be implemented by the user interface 104. In some examples, the user interface 104 may be instantiated by programmable circuitry such as the example programmable circuitry 712 of FIG. 7. For instance, the user interface 104 may be instantiated by the example microprocessor 800 of FIG. 8 executing machine executable instructions such as those implemented by at least block 202 of FIG. 2. In some examples, the user interface 104 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the user interface 104 may be instantiated by any other combination of hardware, software, and/or firmware. For example, the user interface 104 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example video interface 106 is a file upload interface that may be accessed by the physical therapist computing device 132 to provide one or more videos for analysis. Alternatively, the video interface 106 may be a camera that may be utilized by the physical therapist to film a demonstration of the exercise.

In some examples, the video interface 106 is instantiated by programmable circuitry executing user interface instructions and/or configured to perform operations such as those represented by the flowchart(s) of FIGS. 2-3.

In some examples, the exercise profiling device 102 includes means for video interface. For example, the means for video interface may be implemented by the video interface 106. In some examples, the video interface 106 may be instantiated by programmable circuitry such as the example programmable circuitry 712 of FIG. 7. For instance, the video interface 106 may be instantiated by the example microprocessor 800 of FIG. 8 executing machine executable instructions such as those implemented by at least block 204 of FIG. 2. In some examples, the video interface 106 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the video interface 106 may be instantiated by any other combination of hardware, software, and/or firmware. For example, the video interface 106 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example video analyzer 108 analyzes a video(s) demonstration of an exercise and any other characteristics provided in conjunction with the video(s) to determine information about the exercise. The example video analyzer 108 utilizes machine learning (e.g., machine learning models for video analysis) to determine information about the exercise (e.g., starting body position, ending body position, intermediate body positions at points throughout an exercise, etc.).

In some examples, the video analyzer 108 is instantiated by programmable circuitry executing user interface instructions and/or configured to perform operations such as those represented by the flowchart(s) of FIGS. 2-3.

In some examples, the exercise profiling device 102 includes means for video analysis. For example, the means for video analysis may be implemented by the video analyzer 108. In some examples, the video analyzer 108 may be instantiated by programmable circuitry such as the example programmable circuitry 712 of FIG. 7. For instance, the video analyzer 108 may be instantiated by the example microprocessor 800 of FIG. 8 executing machine executable instructions such as those implemented by at least blocks 206-208 of FIG. 2. In some examples, the video analyzer 108 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the video analyzer 108 may be instantiated by any other combination of hardware, software, and/or firmware. For example, the video analyzer 108 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example profile generator 110 generates a profile of an analysis exercise and causes the profile to be stored in the datastore 112. For example, the profile generator 110 may generate a data structure that includes characteristics of the exercise, video demonstration of the exercise, etc.

In some examples, the video analyzer 108 is instantiated by programmable circuitry executing user interface instructions and/or configured to perform operations such as those represented by the flowchart(s) of FIGS. 2-3.

In some examples, the exercise profiling device 102 includes means for profile generation. For example, the means for profile generation may be implemented by the profile generator 110. In some examples, the profile generator 110 may be instantiated by programmable circuitry such as the example programmable circuitry 712 of FIG. 7. For instance, the profile generator 110 may be instantiated by the example microprocessor 800 of FIG. 8 executing machine executable instructions such as those implemented by at least blocks 210-212 of FIG. 2. In some examples, the profile generator 110 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the profile generator 110 may be instantiated by any other combination of hardware, software, and/or firmware. For example, the profile generator 110 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The datastore 112 of the illustrated example is a database in which exercise profiles are stored. Alternatively, the datastore 112 may be any other type(s) of data storage such as local storage, cloud storage, disk storage, memory storage, etc.

The example network 122 is the internet. Alternatively, the network 122 may be any other type(s) of network such as a local network, a wide area network, a wired network, a wireless network, etc. While a single network is illustrated, the network 122 may include any number of networks.

The physical therapist computing device 132 is a personal computer. Alternatively, the physical therapist computing device 132 may be any type(s) of computing devices such as a mobile computing device, a desk computer, a laptop computer, etc. While the example system 100 includes a physical therapist computing device 132 that is separate from the exercise profiling device 102, in some implementations that components of the exercise profiling device 102 may be implemented on the physical therapist computing device 132.

The patient computing device 142 is a personal computer. Alternatively, the patient computing device 142 may be any type(s) of computing devices such as a mobile computing device, a desk computer, a laptop computer, etc. While the example system 100 includes a physical therapist computing device 132 that is separate from the patient computing device 142, in some implementations a single computer may implement the physical therapist computing device 132 and the patient computing device 142 (e.g. where a computing device located in a physical therapist's office it utilized for working to generate new exercise profiles and is utilized by clients when monitoring exercises).

that components of the exercise profiling device 102 may be implemented on the physical therapist computing device 132.

While an example manner of implementing the exercise profiling device 102 is illustrated in FIG. 1, one or more of the elements, processes, and/or devices illustrated in FIG. 1 may be combined, divided, re-arranged, omitted, eliminated, and/or implemented in any other way. Further, the example user interface 104, the example video interface 106, the example video analyzer 108, the example profile generator 110 and/or, more generally, the example exercise profiling device 102 of FIG. 1, may be implemented by hardware alone or by hardware in combination with software and/or firmware. Thus, for example, any of the example user interface 104, the example video interface 106, the example video analyzer 108, the example profile generator 110 and/or, more generally, the example exercise profiling device 102 of FIG. 1, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example exercise profiling device 102 of FIG. 1 may include one or more elements, processes, and/or devices in addition to, or instead of, those illustrated in FIG. 1, and/or may include more than one of any or all of the illustrated elements, processes and devices.

Flowchart(s) representative of example machine readable instructions, which may be executed by programmable circuitry to implement and/or instantiate the exercise profiling device of FIG. 1 and/or representative of example operations which may be performed by programmable circuitry to implement and/or instantiate the exercise profiling device of FIG. 1, are shown in FIGS. 2-3. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 2-3, many other methods of implementing the example exercise profiling device 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 2-3 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 2 is a flowchart representative of example machine readable instructions and/or example operations 200 that may be executed, instantiated, and/or performed by programmable circuitry to generate an exercise profile and present the exercise to a patient. The example machine-readable instructions and/or the example operations 200 of FIG. 2 begin at block 202, at which the user interface 104 provides a user interface to obtain an indication of a characteristic of an exercise. The video interface 106 obtains a video of the exercise (block 204). For example, a physical therapist may upload one or more videos to the video interface 106.

The example video analyzer 108 analyzes the video to detect body position (block 206). For example, the video analyzer 108 may determine a starting body position based on the video. The video analyzer 108 additionally analyzes the video to determined movement depicted in the video (block 208). Based on the input characteristics, the detected body position, and the movement determined from video analysis, profile generator 110 generates an exercise profile (block 210). The profile generator 110 stores the exercise profile in the datastore 112 (block 212).

When a patient accesses the system (e.g., via the patient computing device 142), the exercise is presented to the user (block 214). For example, a video and/or instructions associated with the exercise may be presented to the user. The user then performs the exercise and the performance of the exercise is analyzed (block 216). For example, the patent computing device 142 may include a camera on which a user records themself performing the exercise and machine learning analysis may be utilized to monitor the performance of the exercise for repetition, quality, proper form, etc.

FIG. 3 is a flowchart representative of example machine readable instructions and/or example operations 300 that may be executed, instantiated, and/or performed by programmable circuitry to generate an exercise profile. The example machine-readable instructions and/or the example operations 300 of FIG. 3 begin at block 302 when the physical therapist opens a user interface console. The physical therapist inputs static parameters (e.g., exercise name, starting position, etc.) and selects from among several possible modules for analysis of an exercise collected by the user interface 104 (block 304). The video analyzer 108 determines if there are analysis modules that have been selected and not yet performed (block 306). When there are additional modules, the physical therapist uploads videos via the video interface 106 (or previously uploaded videos are accessed) (block 308).

For example, there may be several modules that analyze a video for profile generation and exercise performance. Example modules include:
Repetition Counting Module: Function: This module is responsible for counting the number of repetitions performed by the patient during the exercise. Description: It uses the skeleton estimation data to track the movement of specific joints and determine when a complete repetition has been performed. The module can be configured to count repetitions based on different criteria, such as the range of motion or specific joint angles.
Metrics Module: Function: This module monitors various metrics related to the exercise, such as range-of-motion, posture, and weights used. Description: It collects data from the skeleton estimation module and other sensors to provide real-time feedback on the patient's performance. The metrics module can track multiple parameters simultaneously and provide detailed reports on the exercise session.
Precheck Module: Function: This module verifies that the patient is in the correct starting position before beginning the exercise. Description: It uses the person detection and skeleton estimation modules to ensure that the patient's posture and equipment setup match the predefined requirements for the exercise. If the patient is not in the correct position, the module provides feedback to guide them into the proper posture.
Qualitative Check Module: Function: This module assesses whether the patient is performing the exercise correctly throughout the session. Description: It continuously monitors the patient's movements and compares them against the ideal exercise form. The module can detect deviations from the correct form and provide real-time feedback to help the patient adjust their technique.
Equipment Module: Function: This module verifies the interaction between the patient and the equipment relevant to the exercise. Description: It ensures that the patient is using the correct equipment and that it is being used properly. The module can detect issues such as incorrect equipment setup or improper handling and provide corrective feedback.
General Person Detection Module: Function: This foundational module is responsible for detecting the presence and position of the patient within the exercise area. Description: It uses computer vision techniques to identify the patient and track their movements. This module provides the basic data required for the other modules to function effectively.
Skeleton Estimation Module: Function: This module estimates the patient's skeletal structure and joint positions in real-time. Description: It uses advanced algorithms to generate a detailed model of the patient's skeleton, which is used by other modules to monitor posture, movement, and exercise performance.
Scenery Verification Modules: Function: These additional modules ensure that the exercise environment is suitable for the session. Description: They include checks for factors such as the presence of other people near the patient, adequate lighting conditions, and a clear exercise area. These modules help maintain a safe and effective exercise environment.

The video analyzer 108 generates a temporary configuration for the exercise (block 310) and processes the video to generate a temporary profile (e.g., for review by the physical therapist) (block 312). If the physical therapist indicates that the temporary profile is not correct (block 314), control returns to block 308 to update the profile (e.g., via updated configuration information provided by the physical therapist). If the physical therapist indicates that the temporary profile is acceptable, control returns to block 306 to determine if there are additional modules to be performed.

When there are no additional modules to be performed, the profile generator 110 saves the generated profile to the datastore 112 (block 316).

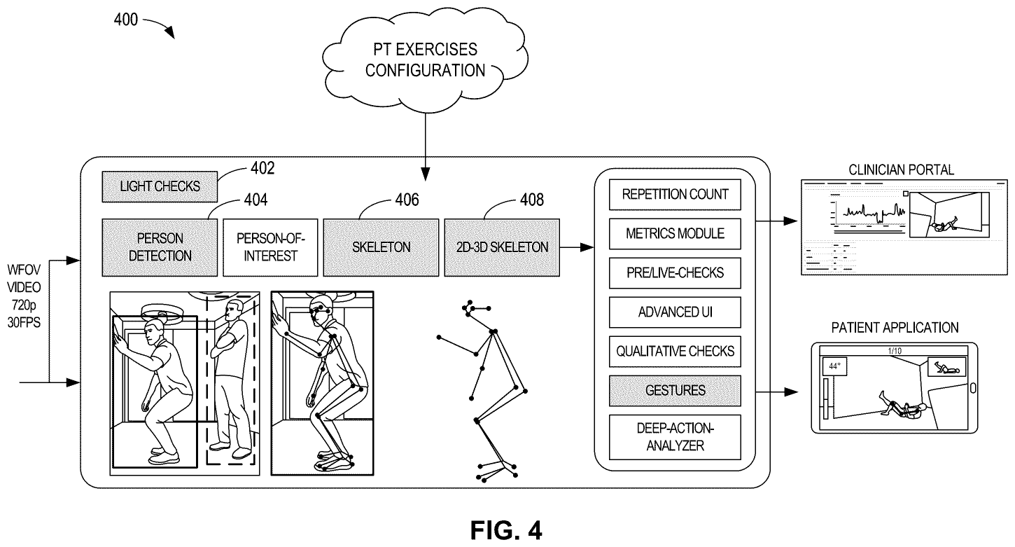

FIG. 4 is a diagram of a system 400 for presenting and analyzing performance of an exercise. The example system 400 includes components to analyze a lighting level in the video (block 402), detect a person in the video (e.g., a person performing an exercise) (block 404), detect a skeleton position (block 406), determine a 3d skeleton form (block 408), etc. The result of the analysis may be utilized by the various modules of the system.

FIG. 5 illustrates an example user interface 500 that may be provided by the example user interface 104. The user interface 500 enables a physical therapist to submit metadata and static data of the new exercise, one or more videos, etc.

FIG. 6 illustrates an example user interface 600 illustrating an interface for configuring repetition counting. The example user interface enables a physical therapist to review a video in a video presentation interface 602 and provide indications of characteristics regarding the events in the video (e.g., exercise peaks, troughs, starts, ends, etc.) to enable a determination of when a first repetition of an exercise begins and ends.

FIG. 7 is a block diagram of an example programmable circuitry platform 700 structured to execute and/or instantiate the example machine-readable instructions and/or the example operations of FIGS. 2-3 to implement the exercise profiling device of FIG. 1. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, VPUs, DSPs, and/or microcontrollers from any desired family or manufacturer. The programmable circuitry 712 may be implemented by one or more semiconductor based (e.g., silicon based) devices. In this example, the programmable circuitry 712 implements ______, ______ and ______.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 2-3, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 2-3 to effectively instantiate the circuitry of FIG. 1 as logic circuits to perform operations corresponding to those machine readable instructions. In some such examples, the circuitry of FIG. 1 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 2-3.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 2-3 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 2-3. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 2-3. As such, the FPGA circuitry 900 may be configured and/or structured to effectively instantiate some or all of the operations/functions corresponding to the machine readable instructions of the flowchart(s) of FIGS. 2-3 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 2-3 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 2-3 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 2-3 to perform first operation(s)/function(s), the FPGA circuitry 900 of FIG. 9 may be configured and/or structured to perform second operation(s)/function(s) corresponding to a second portion of the machine readable instructions represented by the flowcharts of FIG. 2-3, and/or an ASIC may be configured and/or structured to perform third operation(s)/function(s) corresponding to a third portion of the machine readable instructions represented by the flowcharts of FIGS. 2-3.

It should be understood that some or all of the circuitry of FIG. 1 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 1 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

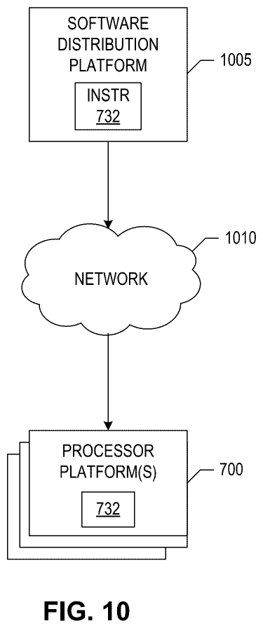

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 2-3, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. 2-3, may be downloaded to the example programmable circuitry platform 700, which is to execute the machine readable instructions 732 to implement the exercise profiling device. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time + 1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that generate an exercise profile based on characteristics and a video(s) demonstrating the exercise. Disclosed systems, apparatus, articles of manufacture, and methods improve the efficiency of using a computing device by determining a profile of an exercise without the need for manual generation of the exercise profile. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to methods and apparatus to generate physical therapy exercise profiles are disclosed herein. Further examples and combinations thereof include the following:
Example 1 includes a non-transitory machine readable storage medium comprising instructions to cause programmable circuitry to at least obtain, via a user interface, an indication of a characteristic for an exercise, obtain, via the user interface, a video depicting a person performing the exercise, analyze, using a machine learning algorithm, the video to detect a body position and a movement of the person performing the exercise, and cause an exercise profile to be stored for the exercise, the exercise profile including the indication of the characteristic for the exercise, an identification of the body position, and an identification of the movement.
Example 2 includes the non-transitory machine readable medium of example 1, wherein the characteristic is a body position of the person depicted in the video.
Example 3 includes the apparatus of any one or more of examples 1-2, wherein the instructions, when executed, cause the programmable circuitry to present the exercise to a user.
Example 4 includes the non-transitory machine readable medium of example 3, wherein the instructions, when executed, cause the machine to obtain a second video of an exercise participant performing the exercise, analyze, using the machine learning algorithm, the second video to determine metadata of the exercise participant performing the exercise, compare the metadata to the exercise profile, and present an indication of the comparison via a graphical user interface.
Example 5 includes the apparatus of any one or more of examples 1-4, wherein the instructions, when executed, cause the programmable circuitry to analyze, using the machine learning algorithm, the video to determine a starting partition for the exercise.
Example 6 includes the apparatus of any one or more of examples 1-5, wherein the instructions, when executed, cause the programmable circuitry to obtain, via the user interface, a plurality of videos depicting the person performing the exercise, and analyze, using the machine learning algorithm, the plurality of videos to detect the body position and the movement of the person performing the exercise.
Example 7 includes the apparatus of any one or more of examples 1-6, wherein the instructions, when executed, cause the programmable circuitry to present a second user interface to obtain a modified to the exercise profile.
Example 8 includes an apparatus comprising machine readable instructions, and programmable circuitry to at least one of instantiate or execute the machine readable instructions to obtain, via a user interface, an indication of a characteristic for an exercise, obtain, via the user interface, a video depicting a person performing the exercise, analyze, using a machine learning algorithm, the video to detect a body position and a movement of the person performing the exercise, and cause an exercise profile to be stored for the exercise, the exercise profile including the indication of the characteristic for the exercise, an identification of the body position, and an identification of the movement.
Example 9 includes the apparatus of example 8, wherein the characteristic is a body position of the person depicted in the video.
Example 10 includes the apparatus of any one or more of examples 8-9, wherein the programmable circuitry is to present the exercise to a user.
Example 11 includes the apparatus of example 10, wherein the programmable circuitry is to obtain a second video of an exercise participant performing the exercise, analyze, using the machine learning algorithm, the second video to determine metadata of the exercise participant performing the exercise, compare the metadata to the exercise profile, and present an indication of the comparison via a graphical user interface.
Example 12 includes the apparatus of any one or more of examples 8-11, wherein the programmable circuitry is to analyze, using the machine learning algorithm, the video to determine a starting partition for the exercise.
Example 13 includes the apparatus of any one or more of examples 8-12, wherein the programmable circuitry is to obtain, via the user interface, a plurality of videos depicting the person performing the exercise, and analyze, using the machine learning algorithm, the plurality of videos to detect the body position and the movement of the person performing the exercise.
Example 14 includes the apparatus of any one or more of examples 8-13, wherein the programmable circuitry is to present a second user interface to obtain a modified to the exercise profile.
Example 15 includes a method comprising obtaining, via a user interface, an indication of a characteristic for an exercise, obtaining, via the user interface, a video depicting a person performing the exercise, analyzing, using a machine learning algorithm, the video to detect a body position and a movement of the person performing the exercise, and causing an exercise profile to be stored for the exercise, the exercise profile including the indication of the characteristic for the exercise, an identification of the body position, and an identification of the movement.
Example 16 includes the method of example 15, wherein the characteristic is a body position of the person depicted in the video.
Example 17 includes the method of any one or more of examples 15-16, further comprising presenting the exercise to a user.
Example 18 includes the method of example 17, further comprising obtaining a second video of an exercise participant performing the exercise, analyzing, using the machine learning algorithm, the second video to determine metadata of the exercise participant performing the exercise, comparing the metadata to the exercise profile, and presenting an indication of the comparison via a graphical user interface.
Example 19 includes the method of any one or more of examples 15-18, further comprising analyzing, using the machine learning algorithm, the video to determine a starting partition for the exercise.
Example 20 includes the method of any one or more of examples 15-19, further comprising obtaining, via the user interface, a plurality of videos depicting the person performing the exercise, and analyzing, using the machine learning algorithm, the plurality of videos to detect the body position and the movement of the person performing the exercise. The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A non-transitory machine readable storage medium comprising instructions to cause programmable circuitry to at least:
obtain, via a user interface, an indication of a characteristic for an exercise;
obtain, via the user interface, a video depicting a person performing the exercise;
analyze, using a machine learning algorithm, the video to detect a body position and a movement of the person performing the exercise; and
cause an exercise profile to be stored for the exercise, the exercise profile including the indication of the characteristic for the exercise, an identification of the body position, and an identification of the movement.

2. The non-transitory machine readable medium of claim 1, wherein the characteristic is a body position of the person depicted in the video.

3. The non-transitory machine readable medium of claim 1, wherein the instructions, when executed, cause the programmable circuitry to present the exercise to a user.

4. The non-transitory machine readable medium of claim 3, wherein the instructions, when executed, cause the machine to:
obtain a second video of an exercise participant performing the exercise;
analyze, using the machine learning algorithm, the second video to determine metadata of the exercise participant performing the exercise;
compare the metadata to the exercise profile; and
present an indication of the comparison via a graphical user interface.

5. The non-transitory machine readable medium of claim 1, wherein the instructions, when executed, cause the programmable circuitry to analyze, using the machine learning algorithm, the video to determine a starting partition for the exercise.

6. The non-transitory machine readable medium of claim 1, wherein the instructions, when executed, cause the programmable circuitry to:
obtain, via the user interface, a plurality of videos depicting the person performing the exercise; and
analyze, using the machine learning algorithm, the plurality of videos to detect the body position and the movement of the person performing the exercise.

7. The non-transitory machine readable medium of claim 1, wherein the instructions, when executed, cause the programmable circuitry to present a second user interface to obtain a modified to the exercise profile.

8. An apparatus comprising:
machine readable instructions; and
programmable circuitry to at least one of instantiate or execute the machine readable instructions to:
obtain, via a user interface, an indication of a characteristic for an exercise;
obtain, via the user interface, a video depicting a person performing the exercise;
analyze, using a machine learning algorithm, the video to detect a body position and a movement of the person performing the exercise; and
cause an exercise profile to be stored for the exercise, the exercise profile including the indication of the characteristic for the exercise, an identification of the body position, and an identification of the movement.

9. The apparatus of claim 8, wherein the characteristic is a body position of the person depicted in the video.

10. The apparatus of claim 8, wherein the programmable circuitry is to present the exercise to a user.

11. The apparatus of claim 10, wherein the programmable circuitry is to:
obtain a second video of an exercise participant performing the exercise;
analyze, using the machine learning algorithm, the second video to determine metadata of the exercise participant performing the exercise;
compare the metadata to the exercise profile; and
present an indication of the comparison via a graphical user interface.

12. The apparatus of claim 8, wherein the programmable circuitry is to analyze, using the machine learning algorithm, the video to determine a starting partition for the exercise.

13. The apparatus of claim 8, wherein the programmable circuitry is to:
obtain, via the user interface, a plurality of videos depicting the person performing the exercise; and
analyze, using the machine learning algorithm, the plurality of videos to detect the body position and the movement of the person performing the exercise.

14. The apparatus of claim 8, wherein the programmable circuitry is to present a second user interface to obtain a modified to the exercise profile.

15. A method comprising:
obtaining, via a user interface, an indication of a characteristic for an exercise;
obtaining, via the user interface, a video depicting a person performing the exercise;
analyzing, using a machine learning algorithm, the video to detect a body position and a movement of the person performing the exercise; and
causing an exercise profile to be stored for the exercise, the exercise profile including the indication of the characteristic for the exercise, an identification of the body position, and an identification of the movement.

16. The method of claim 15, wherein the characteristic is a body position of the person depicted in the video.

17. The method of claim 15, further comprising presenting the exercise to a user.

18. The method of claim 17, further comprising:
obtaining a second video of an exercise participant performing the exercise;
analyzing, using the machine learning algorithm, the second video to determine metadata of the exercise participant performing the exercise;
comparing the metadata to the exercise profile; and
presenting an indication of the comparison via a graphical user interface.

19. The method of claim 15, further comprising analyzing, using the machine learning algorithm, the video to determine a starting partition for the exercise.

20. The method of claim 15, further comprising:
obtaining, via the user interface, a plurality of videos depicting the person performing the exercise; and
analyzing, using the machine learning algorithm, the plurality of videos to detect the body position and the movement of the person performing the exercise.
